(19) United States
(12) Patent Application Publication
(10) Pub. No.: US 2025/0101793 A1
(43) Pub. Date: Mar. 27, 2025

(54) Method and System for Opening a Door of a Motor Vehicle

(71) Applicant: Bayerische Motoren Werke Aktiengesellschaft, Muenchen (DE)

(72) Inventors: Daniel Kuelzer, Muenchen (DE); Olaf Mueller, Emmering (DE)

(21) Appl. No.: 18/728,984

(22) PCT Filed: Nov. 25, 2022
(86) PCT No.: PCT/EP2022/083231

§ 371 Date: Jul. 15, 2024

(30) Foreign Application Priority Data
Jan. 27, 2022 (DE) 10 2022 101 842.3

(51) Int. Cl. E05F 15/76; G01S 5/02

(52) U.S. Cl. CPC E05F 15/76; G01S 5/0294; E05Y 2400/8515; E05Y 2900/531

(57) ABSTRACT

A method for opening a door of a motor vehicle is disclosed herein. The method includes scanning for a user terminal configured to open a door of the motor vehicle, and determining a trajectory of the user terminal when a distance between the user terminal and the motor vehicle is less than a minimum distance. The method further includes comparing the determined trajectory with at least one predefined trajectory, and opening the door of the motor vehicle when the determined trajectory matches a trajectory of the at least one predefined trajectory. The method is implemented by a motor vehicle including one or more interfaces configured to scan for the user terminal, and a controller in communication with the one or more interfaces.

### CROSS-REFERENCE TO RELATED APPLICATIONS

The present application is the U.S. national phase of PCT Application PCT/EP2022/083231 filed on Nov. 25, 2022, which claims priority of German patent application No. 10 2022 101 842.3 filed on Jan. 27, 2022, the entire contents of which are incorporated herein by reference.

### FIELD

The present disclosure relates to the field of motor vehicles and particularly to a method and system for opening a door of a motor vehicle. As disclosed in further detail herein, the present document discloses a system for opening a door of a motor vehicle by comparing a determined trajectory with a predefined trajectory.

### BACKGROUND

Existing systems for opening a door of a motor vehicle, for example a tailgate, use so-called smart openers, which make opening possible, for example, by means of a gesture performed with a foot. This makes it possible to open the tailgate in particular without hands. Other methods use the detection of a smart device staying in the immediate vicinity of a door that is to be opened. In this case, the door can be opened after a predefined period of time has been exceeded. Both the gesture to be performed with a foot and the wait for a door to open can be perceived as unpleasant by a user.

There is therefore a need to provide a concept for improving the opening of a door of a motor vehicle.

### SUMMARY

Exemplary embodiments are based on the core idea that the opening of a motor vehicle door can be improved by determining a trajectory of a user terminal and by opening the door of the motor vehicle depending on a comparison of the determined trajectory with at least one predefined trajectory. This makes it possible, for example, to dispense with a gesture for opening the door and/or a waiting time, which can improve a user experience.

Exemplary embodiments relate to a method for opening a door of a motor vehicle. The method involves scanning for a user terminal configured to open a door of the motor vehicle and determining a trajectory of the user terminal that is configured to open a door of the motor vehicle if the distance between the user terminal and the motor vehicle is less than a minimum distance. The method also includes comparing the determined trajectory with at least one predefined trajectory and opening the door of the motor vehicle if the determined trajectory matches a trajectory that corresponds to at least one predefined trajectory. By comparing the determined trajectory with the at least one predefined trajectory, an intention to open of a user of the user terminal can be determined. For example, a user may be aware of a predefined trajectory that can lead to opening of the door of the motor vehicle. By moving along this at least one predefined trajectory, the user can thus open the door of the motor vehicle by means of a user terminal. This can improve a user experience when opening the door of the motor vehicle. In particular, no further interaction of the user can be required beyond moving along the trajectory.

With some exemplary embodiments, the method may also include determining a part of the trajectory and comparing the determined part of the trajectory with at least one predefined trajectory. Furthermore, the method may include outputting information to a user of the user terminal that the user is on a trajectory that leads to opening of the door of the motor vehicle. This can inform a user that opening the door of the motor vehicle will be carried out if the user continues to move along the trajectory, i.e. in particular the trajectory runs to the end. The user can then prevent the opening of the door of the motor vehicle by leaving the trajectory or stopping, for example.

With some exemplary embodiments, the door of the motor vehicle can only be opened if there is less than a minimum distance between the user terminal and the motor vehicle. By determining a minimum distance, an additional parameter can be defined to avoid false triggers.

With some exemplary embodiments, the scanning for the user terminal can be carried out using a Bluetooth transmitter. Furthermore, the method may include activating an ultra-wideband (UWB) transmitter when the distance is less than the minimum distance, wherein the trajectory is determined by means of the ultra-wideband transmitter. For example, a scan can be carried out by means of UWB only if the user terminal is within range of the UWB transmitter of the motor vehicle, which can minimize energy requirements.

With some exemplary embodiments, the method may also include obtaining information about a surrounding area of the door and selecting a predefined trajectory the received about the depending on information surrounding area. As a result, for example, a trajectory that is used for comparison can be adjusted and/or opening the door of the motor vehicle can be prevented (for example, by the at least one trajectory only including a non-retrievable trajectory), whereby opening the door of the motor vehicle can be adapted to a surrounding area.

With some exemplary embodiments, the method may also include storage of a plurality of determined trajectories and adjusting the at least one predefined trajectory by means of the plurality of determined trajectories. This allows the at least one predefined trajectory to be adapted to the user behavior of the user of the user terminal. For example, a user of the user terminal may choose the same trajectory multiple times to approach their motor vehicle. This trajectory can then be used in particular for a future comparison with a determined trajectory.

With some embodiments, the adjustment of the at least one predefined trajectory can be carried out by an artificial intelligence. In particular, this can improve the adjustment of the at least one predefined trajectory.

Exemplary embodiments also provide a computer program for carrying out one of the methods described herein when the computer program runs on a computer, a processor, or a programmable hardware component.

Another exemplary embodiment is a device for a motor vehicle for opening a door of the motor vehicle. The device contains one or more interfaces for communication with other communication devices (for example the user terminal) and a control module, which is designed to carry out at least one of the methods described herein. Exemplary embodiments also provide a motor vehicle with a device as described herein.

### BRIEF DESCRIPTION OF THE DRAWINGS

Exemplary embodiments are explained in more detail below with reference to the enclosed figures. In the figures:

FIG. 1 shows a schematic representation of an example of a method for opening a door of a motor vehicle;

FIG. 2 shows a block diagram of an exemplary embodiment of a device for a motor vehicle; and

FIGS. 3a-c show schematic representations of a motor vehicle and various determined/predefined trajectories.

Various exemplary embodiments are now described in more detail with reference to the enclosed drawings, in which some exemplary embodiments are shown. In the figures, the thickness dimensions of lines, layers and/or regions will be exaggerated for reasons of clarity.

### DESCRIPTION

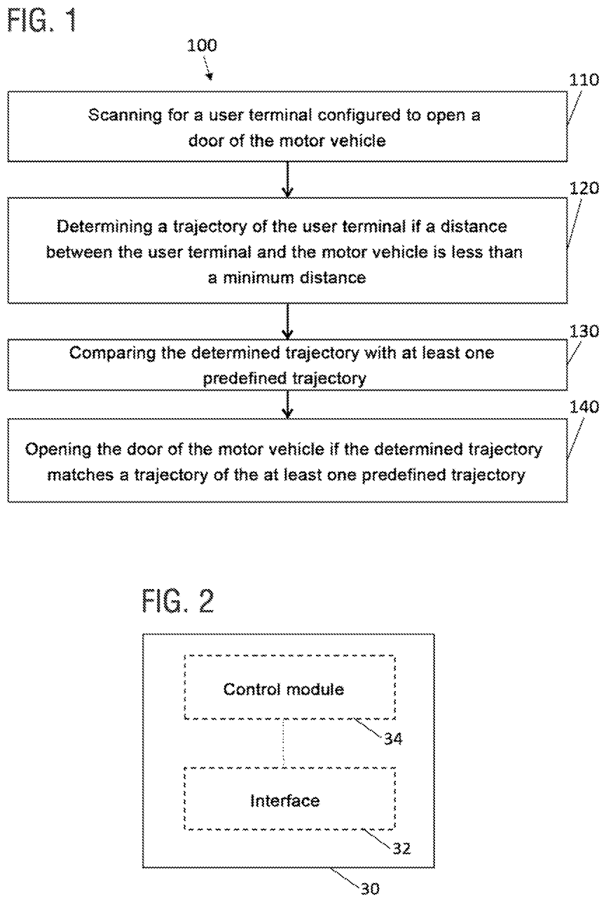

FIG. 1 shows a schematic representation of an example of a method 100 for opening a door of a motor vehicle. The method involves scanning 110 for a user terminal that is configured to open a door of the motor vehicle and determining 120 a trajectory of the user terminal if the distance between the user terminal and the motor vehicle is less than a minimum distance. Furthermore, the method includes comparing 130 the determined trajectory with at least one predefined trajectory and opening 140 the door of the motor vehicle if the determined trajectory matches a trajectory that corresponds to at least one predefined trajectory. As a result, a door of the motor vehicle can be opened without a required gesture and/or a user waiting time. In particular, this can improve a user experience.

For example, scanning 110 can be carried out using a Wireless Personal Area Network (WPAN), for example Bluetooth, etc. Scanning 110 can be carried out, for example, by means of a transponder or transmitter for near-field communication, for example by means of a Bluetooth transmitter of the motor vehicle.

The user equipment (UE) can generally be a device that is capable of communicating wirelessly. In particular, the UE is a mobile UE, for example a UE that is capable of being carried by a user. The UE can be, for example, a user terminal (UT) or user equipment (UE) in the sense of the respective communication standards used for mobile communication. For example, the UE can be a mobile phone, such as a smartphone, or another type of mobile communication device, such as a smartwatch, a laptop, a tablet computer, autonomous augmented reality glasses, etc.

In particular, the UE may be a digital key within the meaning of the Car Connectivity Consortium (CCC) standard. For example, the CCC-TS-101 Digital Key Technical Specification Release 3, version 1.0.0 standard can be used for communication between the UE and the motor vehicle.

The UE is configured to open a door of the motor vehicle. For example, the UE can be known to the motor vehicle, for example to a Bluetooth receiver of the motor vehicle. For example, the UE may have been associated with the motor vehicle by a pairing process, and the motor vehicle may recognize the UE, for example an identification of the UE. For example, the motor vehicle may have a whitelist that lists UEs that are configured to open the door of the motor vehicle. This allows the motor vehicle to scan 100 specifically for suitable UEs when scanning.

Determining 120 a trajectory of the UE can be carried out in particular by means of a WPAN. Alternatively, the determination 120 of the trajectory of the UE can be done using ultra-wideband technology (UWB). In particular, a transponder or transmitter of the motor vehicle may be designed to enable communication with the UE by means of WPAN and/or UWB. In particular, the UE can also be designed for UWB communication.

In particular, the minimum distance can be a distance that enables reliable determination by means of wireless communication technology, for example by means of UWB. For example, the minimum distance for UWB can be less than 14 m or 12 m or 10 m or 8 m. As a result, a determination of the trajectory can only be started in particular when the UE is within the range of the wireless communication technology, for example within the range of a UWB transmitter of the motor vehicle. In particular, this can reduce energy consumption. Optionally or additionally, the minimum distance may depend on a location and/or surrounding area of the motor vehicle. For example, the motor vehicle may be parked in a garage and a minimum distance may be designed so that the determination 120 only occurs when the UE is inside the garage.

Comparing 130 the determined trajectory with at least one predefined trajectory can be carried out by a computing unit of the motor vehicle, such as a control unit (ECU). The at least one predefined trajectory may in particular contain a spatial area. For example, the at least one predefined trajectory can contain a spatial area and the determined trajectory can be identical with the at least one predefined trajectory if the determined trajectory is within the spatial area of the predefined trajectory.

Opening 140 the door of the motor vehicle can then be controlled, for example, by the ECU. In particular, a door can be any device of the motor vehicle that can be opened, for example a tailgate, a front flap, a door for a driver, a door for a front passenger/passenger.

In an exemplary embodiment, the method 100 may also include determining a part of the trajectory and comparing the determined part of the trajectory with at least a predefined trajectory. Furthermore, the method 100 may include outputting information to a user of the user terminal that the user is on a trajectory which leads to opening the door of the motor vehicle. This allows the user to be informed that opening 140 the door of the motor vehicle may be possible. In particular, the user can receive information that enables them to prevent the door of the motor vehicle from opening 140. For example, the user can cancel a trajectory after receiving the information, for example by leaving the trajectory or stopping. In particular, this can prevent unintentional opening of the door of the motor vehicle. The output of the information can be carried out, for example, by means of a device of the motor vehicle, for example by an acoustic signal (a horn), a visual signal (for example flashing a turn signal), transmission of information to the UE (for example, the transmitted information can lead to a vibration of the UE, for example of a smart key), etc.

In an exemplary embodiment, the door of the motor vehicle can only be opened if there is less than a minimum distance between the user terminal and the motor vehicle. In particular, this can reduce the probability of false triggering of opening 140 the door of the motor vehicle. For example, if a determined trajectory matches the at least one predefined trajectory, opening 140 can additionally be dependent on falling below the minimum distance. Optionally or additionally, a delay time can be defined. In particular, the delay time may indicate a time interval that must be exceeded after the ending of the trajectory by the user or after the distance becomes less than minimum distance in order for the door of the motor vehicle to be opened 140. In particular, false triggering of opening 140 of the door of the motor vehicle may be reduced by this.

In an exemplary embodiment, scanning for the user terminal can be carried out using a Bluetooth transmitter or a Bluetooth transponder. In addition, the method 100 may include activating an ultra-wideband transmitter or ultra-wideband transponder (of the motor vehicle) if the distance is less than the minimum distance, wherein the trajectory is determined by means of the ultra-wideband transmitter or ultra-wideband transponder. By using ultra-wideband, the energy required to determine the trajectory can be minimized, especially due to the low frequencies used. In particular, frequencies less than 100 Hz or 50 Hz or 20 Hz or 10 Hz and/or frequencies greater than 3 Hz or 5 Hz can be used. The minimum distance can be identical or approximately identical with a range of the ultra-wideband transmitter or ultra-wideband transponder of the motor vehicle. In addition, targeted activation of the ultra-wideband transmitter or ultra-wideband transponder can result in minimizing the operating time of the ultra-wideband transmitter or ultra-wideband transponder, which can reduce the energy requirement.

In an exemplary embodiment, the method 100 can also include obtaining information about a surrounding area of the door and selecting a predefined trajectory depending the on information obtained about the surrounding area. In particular, this can prevent the door of the motor vehicle from being opened 140 in an unintentional situation, for example a door to be opened may have an obstacle, which means that it may not be possible to open the door of the motor vehicle. By obtaining the information about the surrounding area, it is possible in particular to check whether the door of the motor vehicle can be opened and/or how far a door can be opened. For example, the motor vehicle may be parked in a garage whose height only allows a tailgate to be partially opened.

For example, the motor vehicle can be parked in a known location, for example in a driveway of a property. The motor vehicle can then in particular receive information about the surrounding area by receiving information about its own location. In particular, at least one predefined trajectory can then be selected that corresponds to this location, for example the path from a front door to the motor vehicle parked in the driveway. This at least one predefined trajectory can in particular relate to previously determined trajectories for the same location of the motor vehicle.

The information about the surrounding area can be received (for example by a communication device, for example inside a garage, which informs the motor vehicle about an exact location of the motor vehicle) and/or determined (for example by a sensor of the motor vehicle, for example by a LIDAR sensor, a RADAR sensor, etc.).

In an exemplary embodiment, the method 100 can also include storing a plurality of determined trajectories and adjusting the at least one predefined trajectory by means of the plurality of determined trajectories. In particular, can this improve a comparison between determined trajectories and the at least one predefined trajectory, in particular as a result of the at least one predefined trajectory being changed/adjusted.

In an exemplary embodiment, the adjustment of the at least one predefined trajectory can be carried out by an artificial intelligence. The artificial intelligence can, for example, be implemented on a system (for example a control module of the motor vehicle, for example the ECU, and which control module may also be referred to herein as a “controller”). The artificial intelligence can be designed in particular by means of machine learning.

The system can be configured so that it provides the determined trajectories as input for a machine learning model. Machine learning refers to algorithms and statistical models that computer systems can use to perform a specific task without explicit instructions and instead relying on models and inference. For example, instead of a rule-based transformation of data, machine reading can use a transformation of data derived from an analysis of historical and/or training data.

Machine learning models are trained using training data. To train a machine model, many different approaches can be used. For example, supervised learning, semi-supervised learning or unsupervised learning can be used. In supervised learning, the machine learning model is designed using a variety of training patterns, wherein each pattern can include a variety of input data values and a variety of desired output values, for example each training pattern is associated with a desired output value. By specifying both training patterns and desired output values, the machine model “learns” the output should provide on the basis of an input value that it pattern that is similar to the patterns delivered during training. In addition to supervised learning, semi-supervised learning can also be used. In semi-supervised learning, some of the training patterns lack a corresponding desired output value. Supervised Learning can be based on a supervised learning algorithm, for example a classification algorithm, a regression algorithm or a similarity algorithm. In the case of unsupervised learning, (only) input data can be supplied, and an unsupervised learning algorithm can be used to find a structure in the input data, for example by grouping or clustering the input data to find commonalities in the data.

For example, the machine learning model can be an artificial neural network (ANN). ANNs are systems that are oriented towards biological neural networks, such as those found in the brain. ANNs consist of a large number of interconnected nodes and a large number of connections, called edges, between the nodes. There are usually three types of nodes: input nodes that receive input values, hidden nodes that (only) use other nodes, and output nodes that provide output values. Each node can represent an artificial neuron. Each edge can transfer information from one node to another node. The output of a node can be defined as a (non-linear) function of the sum of its inputs. The inputs of a node can be used in the function based on a “weight” of the edge or node that provides the input. The weight of nodes and/or edges can be adjusted during the learning process. In other words, the training of an artificial neural network can include the adaptation of the weights of the nodes and/or edges of the artificial neural network, for example to achieve a desired output for a given input. In at least some examples, the machine learning model can be a deep neural network, for example a neural network with one or more layers of hidden nodes (for example, hidden layers), preferably a plurality of layers of hidden nodes. In some examples, the machine learning model can be a pointer network.

Machine learning models are typically used by applying input data to an input of the machine learning model and by using the output data provided at an output of the machine learning model. In artificial neural networks the input data are provided to the input nodes of the ANN, the input data are then transformed on the basis of the weights of the edges between the nodes of the artificial neural network and finally output from the output nodes of the ANN. In this case, the information obtained earlier is provided as input to the machine learning model. For example, the ANN can contain one or more embedding layers, a (masked) attention layer, a pointer network layer and a decoding layer for transforming the data between the input layer and the output layer. In other words, the machine learning model can contain one or more embedding layers (for example, one or more layers of a neural network). For example, the one or more embedding layers can be based on a nonlinear activation function, such as the Mish activation function, or based on parametric rectified linear units (PReLU). The system can be configured to provide the information about the determined trajectories as the input to the machine learning model. For example, the system can be configured to use/execute the machine learning model to influence the transformation between the input and the output of the machine learning model.

Training machine learning models requires a considerable amount of effort, so that the reuse of a machine learning model for different problem sizes can reduce the total training time. In various examples of the present disclosure, the machine learning model can be applied to a different number of predefined trajectories, for example to the at least one predefined trajectory.

The system can be configured to receive training input data for the training of the machine model. The training input data can include training information about a number of determined trajectories.

The training input data can be obtained, for example, via an interface, for example an interface of the system. The training input data can be obtained from a database, from a file system or from a data structure stored in a computer memory. The training input data can include training information about determined trajectories. The term “training information” can only indicate that the respective are suitable for training the machine learning model, for example. For example, the training information can include information about the determined trajectories that are representative of the particular data to be processed by the machine learning model, for example to obtain a machine model that is suitable for the present task, for example suitable for the adaptation of the at least one predefined trajectory.

For example, the machine learning model can output information about an adapted trajectory based on the training information about the determined trajectories that can be provided at the input of the machine learning model. In other words, the machine learning model can be provided with the training input data that represent a plurality of determined trajectories, and with the task of finding an improved and/or adapted predefined trajectory.

The machine learning model can be trained, for example, by repeatedly (for example at least twice, at least five times, at least ten times, at least 20 times, at least 50 times, at least 100 times, at least 1000 times) performing a group of training tasks (or method steps). For example, the machine learning model can be trained by repeatedly entering the training input data into the machine learning model, determining an adjusted trajectory based on an output of the machine learning model, evaluating the adjusted trajectory using a reward function (for example, how often a user completes or cancels the trajectory), and adjusting the machine learning model based on a result of the evaluation.

A repetition of the above tasks can be considered an “epoch” in reinforcement learning. An epoch means that the entire set of training input data is passed forward and backward once through the machine learning model. Within an epoch, a large number of batches of training data can be entered into the machine learning model to determine and evaluate the favorability of the adjusted trajectory. To keep the problem size small, the training data can be divided into a plurality of batches, for example, which can be made available separately to the machine model. Each batch from the plurality of batches can be entered into the machine learning model separately.

As mentioned earlier, the machine learning model can contain one or multiple embedding layers, which can be based on a nonlinear activation function, such as a PReLU or Mish activation function. For example, the one or multiple embedding layers, which can be neural network layers, are trained as part of reinforcement training. Similarly, the machine learning model can contain an attention layer, which can also be trained as part of reinforcement learning training.

In one exemplary embodiment, the method 100 may also include closing the door of the motor vehicle if, after opening the door of the motor vehicle, a maximum distance between the user terminal and the motor vehicle is exceeded or a trajectory of the user terminal corresponds to a further predefined trajectory. For example, a tailgate can be closed again if, after the opening of the tailgate, a user or the UE moves away from this again. For example, the tailgate can also be closed after an opening if a user moves on another predefined trajectory, for example from the tailgate to the driver's door of the motor vehicle. In particular, by comparing a further determined trajectory (a trajectory determined after a first opening of a door of the motor vehicle) with a further predefined trajectory, another door of the motor vehicle can be opened and/or the door of the motor vehicle can be closed. In particular, opening the other door of the motor vehicle and closing the door of the motor vehicle can take place essentially at the same time.

In particular, the at least one predefined trajectory can be selected from a plurality of stored trajectories (for example, the plurality of trajectories may be stored in a memory unit of the motor vehicle, for example in the form of a look-up table).

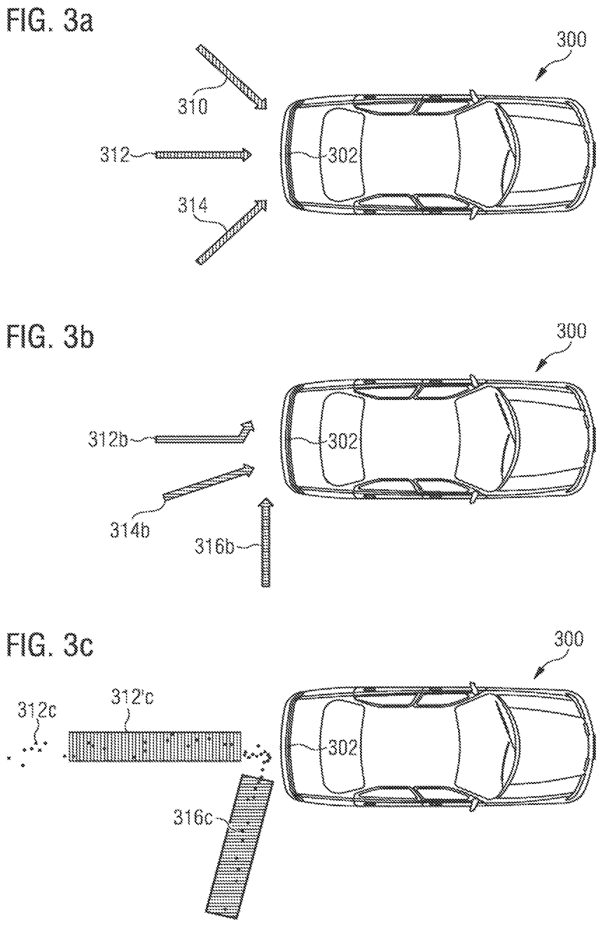

Further details and aspects are mentioned in connection with the exemplary embodiments described below. The exemplary embodiment shown in FIG. 1 may contain one or more optional additional features corresponding to one or more aspects mentioned in connection with the proposed concept or one or more exemplary embodiments described below (for example FIGS. 2-3).

FIG. 2 shows a block diagram of an exemplary embodiment of a device 30 for a motor vehicle. The device 30 for opening a door of a motor vehicle contains one or more interfaces 32 for communication with a user terminal. The device 30 also contains a control module 34 that is designed to carry out at least one of the methods described herein, for example the method described with reference to FIG. 1. Other exemplary embodiments are a motor vehicle with a device 30.

For example, the one or more interfaces 32 can correspond to one or more inputs and/or one or more outputs for receiving and/or transmitting information, for example in digital bit values, based on a code, within a module, between modules, or between modules of different entities. For example, the at least one or more interfaces 32 can be designed to communicate with other network components via a (radio) network or a local connection network.

In exemplary embodiments, the control module 34 can correspond to any controller or processor or programmable hardware component. For example, the control module 34 can also be implemented as software that is programmed for a corresponding hardware component. In this respect, the control module 34 can be implemented as programmable hardware with appropriately adapted software. Any processors, such as digital signal processors (DSPs), can be used. Exemplary embodiments are not limited to a specific type of processor. Any processors or even multiple processors are conceivable for the implementation of the control module 34.

In at least some exemplary embodiments, the motor vehicle may correspond, for example, to a land vehicle, a watercraft, an aircraft, a rail vehicle, a road vehicle, an automobile, a bus, a motorcycle, an off-road vehicle, a motor vehicle, or a truck.

In particular, the control module 34 may be designed to carry out the machine model. For example, the control module may be part of a motor vehicle ECU.

The one or multiple interfaces can be configured in particular to communicate with a receiver/transmitter of the motor vehicle, especially with a receiver/transmitter that can be used to scan for the UE and/or determine the trajectory.

Further details and aspects are mentioned in connection with the exemplary embodiments described below and/or above. The exemplary embodiment shown in FIG. 2 may contain one or more optional additional features that correspond to one or more aspects mentioned in connection with the proposed concept or one or more exemplary embodiments described above (for example FIG. 1) and/or below (for example FIG. 3).

FIGS. 3a-c show schematic representations of a motor vehicle 300 and various determined/predefined trajectories. The motor vehicle 300 contains a device 30 (for example the device 30 described with reference to FIG. 2) for opening a door of the motor vehicle 300. In particular, the motor vehicle 300 may contain a Bluetooth transmitter/receiver/transponder and a UWB transmitter/receiver/transponder. The Bluetooth transmitter/receiver/transponder and the UWB transmitter/receiver/transponder can in particular be designed to scan/cover a surrounding area of the motor vehicle 300.

As can be seen in FIG. 3a, there can be at least one predefined trajectory 310, 312, 314 which can lead to opening of the door, in this case the tailgate 302 of the motor vehicle 300. If a user walks along this trajectory with a UE, the trajectory of the UE/user can be determined and opening of the tailgates 302 can be initiated by a comparison with the predefined trajectory 310, 312, 314. For example, a predefined trajectory 310, 312, 314 may include an angle of approach to the door of the motor vehicle 300. For example, the predefined trajectory 312 may include an angle of approach of 90° to the tailgate 302 (for example, 90° to a centrally located logo on the tailgate 302). For example, a predefined trajectory 310, 312, 314 may encompass a certain width (see also FIG. 3c).

For example, a predefined trajectory can run along the motor vehicle 300 (not shown). This predefined trajectory can be used especially when the motor vehicle 300 is not accessible from the rear, for example is parked in a longitudinal parking bay with several motor vehicles. In particular, the motor vehicle 300 can receive information about a surrounding area (for example may determine it by means of a sensor) and can select at least one predefined trajectory 310, 312, 314 depending on the information about the surrounding area (for example in a longitudinal parking bay, the trajectory along the motor vehicle 300).

For example, the predefined trajectory can be adjusted depending on the information about the surrounding area. The motor vehicle 300 can obtain information about an obstacle, for example a tree, a puddle, etc. on a predefined trajectory (for example may determine it using a LIDAR sensor, a RADAR sensor). A predefined trajectory can then be adjusted so that the predefined trajectory passes around the obstacle, wherein an angle of approach is changed in such a way that a rectilinear trajectory passes the obstacle, etc. This allows a user to leave the (adapted) predefined trajectory and thus cause opening of the tailgate 302 despite the obstacle.

In FIG. 3b various determined trajectories 312b, 314b, 316b are shown, which cannot lead to opening of the tailgate 302 of the motor vehicle 300. For example, for the determined trajectories 314b and 316b the angles of approach are wrong. For example, in the case of the determined trajectory 312b, the user/UE may deviate from a straight line towards the end of the determined trajectory 312b. For example, the user may have received information from the motor vehicle 300 that it is on a predefined trajectory 312a and the tailgate 302 is about to be opened. The user can then deliberately leave the predefined trajectory 312a, which can prevent opening of the tailgate 302.

In FIG. 3c a first determined trajectory 312c and a second determined trajectory 316c can be seen. The first determined trajectory 312c can lead to an opening of the tailgate 302, whereas the second determined trajectory 316c cannot lead to an opening. A predefined trajectory 312′c can be defined in particular by the vertically hatched area. Thus, as soon as a UE is detected outside this area, a comparison between the determined trajectory 312c and the predefined trajectory 312′c cannot result in opening of the tailgate 302. The width and/or length of the predefined trajectory 312′c can be adjusted, especially by the machine learning model (which for example is carried out by the ECU). In particular, the width and/or length can be adjusted based on a plurality of previously determined trajectories, in particular to a surrounding area of the motor vehicle 300. Even though only rectangular trajectories are shown, the trajectory can have any suitable shape, for example curved (especially around an obstacle, along a path), trapezoidal with tapering towards the motor vehicle, etc.

The second determined trajectory 316c, although it lies within an identical width and length as the first determined trajectory 312c, cannot lead to an opening of the tailgate 302. In particular, an angle of approach of the second determined trajectory 316c match can a predefined trajectory.

In particular, trajectories can be defined that result in the opening of the tailgate 302/doors. An example is the perpendicular approach of a user to the motor vehicle 300 or tailgate 302 thereof or a logo of the motor vehicle 300. The user can use a UE, for example a digital key (for example a mobile phone, smart watch, etc.). The digital key can be localized by the motor vehicle 300 using UWB localization at for example 10 Hz. From this, a trajectory can then be determined. The motor vehicle 300 signals to the customer that he has been recognized. The user can exit the trajectory at any time, and the opening of the tailgate 302/door will be stopped/not carried out.

In particular, the determined trajectory 312c of the UE/user can be determined using UWB technology, for example by means of continuous localization (for example at 10 Hz).

In particular, simple predefined trajectories 316′c can be defined, which can lead to the opening of the tailgate 302/door, for example straight trajectories. A schematic sequence could begin with a customer approaching the motor vehicle 300. The last 4 meters can be walked in a predefined trajectory 312′c, specifically in an area 312′c spanned by the predefined trajectory 312′c, (the area of the determined trajectory 312c that is within the predefined trajectory 312′c). At a distance of 2.5 meters, the user can be signaled by taillights with an intention recognition, i.e. an imminent opening of the tailgate 302. The tailgate 302 can be opened at a distance of 1 meter. This can eliminate the need for the user to wait for the tailgate 302 to be opened. Furthermore, an interaction can be as intuitive and unobtrusive as possible (shy tech), just by following a predefined trajectory. The customer can leave this trajectory at any time, wherein the tailgate 302 then cannot open.

A simple realization for the predefined trajectory 312′c can define fixed boundaries in an x-y plane, as well as consider a vector between two localizations. Optionally, machine learning can also be used to determine/adjust the predefined trajectory.

Further details and aspects are mentioned in connection with the exemplary embodiments described above. The exemplary embodiment shown in FIG. 3 may contain one or more optional additional features corresponding to one or more aspects mentioned in connection with the proposed concept or one or more exemplary embodiments described above (for example FIGS. 1-2).

Further exemplary embodiments computer programs for carrying out the methods described herein when the computer program runs on a computer, a processor, or a programmable hardware component. Depending on implementation requirements, exemplary specific embodiments of the disclosure can be implemented in hardware or in software. The implementation can be carried out using a digital memory medium, such as a floppy disk, DVD, Blu-ray Disc, CD, ROM, PROM, EPROM, EEPROM or FLASH memory, hard disk or other magnetic or optical memory on which electronically readable control signals are stored, which can be programmed with a programmable hardware component or can interact in such a way that the respective method is carried out.

A programmable hardware component can be formed by a processor, a computer processor (CPU=Central Processing Unit), a graphics processor (GPU=Graphics Processing a computer, a computer system, an application-specific integrated circuit (ASIC), an integrated circuit (IC), a single-chip system (SOC=System on Chip), a programmable logic element or a field-programmable gate array (FPGA) with a microprocessor.

The digital memory medium can therefore be machine-readable or computer readable. Thus, some exemplary embodiments contain a data carrier which has electronically readable control signals capable of interacting with a programmable computer system or hardware component in such a way that one of the methods mentioned herein carried out. Thus, an exemplary embodiment is a data carrier (or a digital memory medium or a computer-readable medium) on which the program for carrying out any of the methods described herein is recorded.

In general, exemplary embodiments of the present disclosure may be implemented as a program, firmware, computer program or computer program product with a program code or as data, wherein the program code or data is/are effective in carrying out one of the methods when the program runs on a processor or programmable hardware component. The program code or data can also be stored on a machine-readable medium or data carrier, for example. The program code or data may be in the form, inter alia, of source code, machine code or byte code, as well as other intermediate code.

The exemplary embodiments described above are merely an illustration of the principles of the present disclosure. It is understood that modifications and variations of the arrangements and details described herein will be evident to other experts. Therefore, it is intended that the disclosure is only limited by the scope of protection of the following patent claims and not by the specific details presented herein based on the description and the explanation of the exemplary embodiments.

### LIST OF REFERENCE SIGNS

30 Device for opening a door of a motor vehicle
32 Interface
34 Control module
100 Method for opening a door of a motor vehicle
110 Scanning for a user terminal
120 Determining a trajectory of the user terminal
130 Comparing the determined trajectory
140 Opening the door of the motor vehicle
300 Vehicle
302 Tailgate
310, 312, 312c, 314, 316c determined trajectory
312b, 312′c, 314b, 316b predefined trajectory

1.-10. (canceled)

11. A method for opening a door of a motor vehicle, the method comprising:
scanning for a user terminal configured to open a door of the motor vehicle;
determining a trajectory of the user terminal when a distance between the user terminal and the motor vehicle is less than a minimum distance;
comparing the determined trajectory with at least one predefined trajectory; and
opening the door of the motor vehicle when the determined trajectory matches a trajectory of the at least one predefined trajectory.

12. The method as claimed in claim 11, further comprising:
determining a part of the trajectory;
comparing the determined part of the trajectory with at least one predefined trajectory; and
outputting information to a user of the user terminal that the user is on a trajectory that leads to opening the door of the motor vehicle.

13. The method as claimed in claim 11, wherein:
the scanning for the user terminal is carried out using a Bluetooth transmitter, and further comprising:
activating an ultra-wideband transmitter when the distance is less than the minimum distance, wherein the trajectory is determined by means of the ultra-wideband transmitter.

14. The method as claimed in claim 11, further comprising:
obtaining information about a surrounding area of the door; and
selecting a predefined trajectory depending on the information obtained about the surrounding area.

15. The method as claimed in claim 11, further comprising:
storing a plurality of determined trajectories; and
adjusting the at least one predefined trajectory using the plurality of determined trajectories.

16. The method as claimed in claim 15, wherein adjusting the at least one predefined trajectory is carried out by an artificial intelligence.

17. The method as claimed in claim 11, further comprising:
closing the door of the motor vehicle when, after opening the door of the motor vehicle, a maximum distance between the user terminal and the motor vehicle is exceeded or a trajectory of the user terminal corresponds to another predefined trajectory.

18. A non-transient computer readable medium for opening a door of a motor vehicle, wherein the computer-readable medium comprises instructions which, when executed on a controller, causes the controller to:
scan for a user terminal configured to open a door of the motor vehicle;
determine a trajectory of the user terminal when a distance between the user terminal and the motor vehicle is less than a minimum distance;
compare the determined trajectory with at least one predefined trajectory; and
open the door of the motor vehicle when the determined trajectory matches a trajectory of the at least one predefined trajectory.

19. The non-transient computer readable medium as claimed in claim 18, wherein the computer-readable medium further comprises instructions which, when executed on a controller, causes the controller to:
determine a part of the trajectory;
compare the determined part of the trajectory with at least one predefined trajectory; and
output information to a user of the user terminal that the user is on a trajectory that leads to opening the door of the motor vehicle.

20. The non-transient computer readable medium as claimed in claim 18, wherein:
the scanning for the user terminal is carried out using a Bluetooth transmitter, wherein the computer-readable medium further comprises instructions which, when executed on a controller, causes the controller to:
activate an ultra-wideband transmitter when the distance is less than the minimum distance, wherein the trajectory is determined by means of the ultra-wideband transmitter.

21. The non-transient computer readable medium as claimed in claim 18, wherein the computer-readable medium further comprises instructions which, when executed on a controller, causes the controller to:
obtain information about a surrounding area of the door; and
select a predefined trajectory depending on the information obtained about the surrounding area.

22. The non-transient computer readable medium as claimed in claim 18, wherein the computer-readable medium further comprises instructions which, when executed on a controller, causes the controller to:
store a plurality of determined trajectories; and
adjust the at least one predefined trajectory using the plurality of determined trajectories.

23. The non-transient computer readable medium as claimed in claim 22, wherein the computer-readable medium further comprises instructions which, when executed on a controller, causes the controller to:
close the door of the motor vehicle when, after opening the door of the motor vehicle, a maximum distance between the user terminal and the motor vehicle is exceeded or a trajectory of the user terminal corresponds to another predefined trajectory.

24. A motor vehicle configured for communication with a user terminal associated with the motor vehicle, the motor vehicle comprising:
one or more interfaces configured to scan for the user terminal; and
a controller in communication with the one or more interfaces, the controller configured to:
determine a trajectory of the user terminal when a distance between the user terminal and the motor vehicle is less than a minimum distance;
compare the determined trajectory with at least one predefined trajectory; and
open the door of the motor vehicle when the determined trajectory matches a trajectory of the at least one predefined trajectory.

25. The motor vehicle of claim 24, wherein the controller is further configured to:
determine a part of the trajectory;
compare the determined part of the trajectory with at least one predefined trajectory; and
output information to a user of the user terminal that the user is on a trajectory that leads to opening the door of the motor vehicle.

26. The motor vehicle of claim 24, wherein:
the scanning for the user terminal is carried out using a Bluetooth transmitter, the controller further configured to:
activate an ultra-wideband transmitter when the distance is less than the minimum distance, wherein the trajectory is determined by means of the ultra-wideband transmitter.

27. The motor vehicle of claim 24, the controller further configured to:
obtain information about a surrounding area of the door; and
select a predefined trajectory depending on the information obtained about the surrounding area.

28. The motor vehicle of claim 24, the controller further configured to:
store a plurality of determined trajectories; and
adjust the at least one predefined trajectory using the plurality of determined trajectories.

29. The motor vehicle of claim 28, wherein adjusting the at least one predefined trajectory is carried out by an artificial intelligence.

30. The motor vehicle of claim 24, the controller further configured to:
close the door of the motor vehicle when, after opening the door of the motor vehicle, a maximum distance between the user terminal and the motor vehicle is exceeded or a trajectory of the user terminal corresponds to another predefined trajectory.
